(19) United States
(12) Patent Application Publication
(10) Pub. No.: US 2005/0148265 A1
(43) Pub. Date: Jul. 7, 2005

(54) HIGH TEMPERATURE MICROWAVE SUSCEPTOR STRUCTURE

(76) Inventors: Nicole L. Blankenbeckler, Richmond, VA (US); Cheng Hang Chi, Midlothian, VA (US); George B. Palmer, Richmond, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/749,960

(22) Filed: Dec. 31, 2003

(51) Int. Cl. B32B 27/12

(52) U.S. Cl. 442/394; 442/59; 442/327

(57) ABSTRACT

This invention relates to a high temperature microwave susceptor structure comprising a microwave interactive material of carbon with a naturally occurring polymer or derivative and a base layer of a high temperature paper.

### BACKGROUND OF THE INVENTION

1. Field of the Invention

This invention relates to a high temperature microwave susceptor structure comprising a microwave interactive material of carbon deposited on a high temperature nonwoven base layer. Such microwave susceptor structures consistently brown and crisp food cooked in a microwave oven.

2. Description of Related Art

The use of microwave energy to heat foods is well known, however, a major disadvantage is the inability to quickly, sufficiently, and consistently brown the surface of the foods being heated. U.S. Pat. No. 4,892,782 to Fisher discloses the use of fibrous materials such as cotton, cellulose, jute, hemp, acetate, fiberglass, wool, nylon, polyester, aramid, polypropylene, and other polyolefins as base layers for microwave susceptors. Fisher provides examples of suitable base layers such as woven cloth, paper, rayon, Dacron® polyester, cloths woven of Nomex® or Kevlar® aramid fibers, Sontara® spunlaced fabric, and Tyvek® spunbonded olefin sheets for use in microwave applications. Fisher also discloses metals, metal alloys, conductive polymers, poly- and mono-saccharides, and ionically conductive food flavoring agents as useful microwave interactive materials which may be deposited by techniques including vacuum chemical vapor deposition, vacuum metallization, sputtering, and printing.

While Fisher discloses that high temperature base layers are desirable, there is no disclosure concerning how one would combine carbon as a microwave interactive material and a base layer to make a microwavable susceptor structure that has sufficient heat to consistently and safely brown, solely from microwave energy, such things as bread and pizza without additives to the bread or pizza dough. Fisher et. al. does not disclose a distinction between materials that may burn, melt, or char at high temperatures such as cellulosic paper, or Tyvek® and materials that enable high temperature heating and browning without burning, melting, or charring. To brown requires the generation of very high heat in a uniform manner. Efforts to construct such a microwavable system have tended to either burn the base layers or arc due to the non-uniformities in the high level of microwave interactive material used in the microwave susceptor.

What is needed, therefore, is a microwave susceptor structure that can provide very high heat without damaging the base layer.

### SUMMARY OF THE INVENTION

This invention relates to a structure for cooking or heating food, comprising:
a) a nonwoven base layer comprising a polymeric material with glass transition temperature t_{g} greater than 240 degrees Celsius or a melting temperature tₘ greater than 270 degrees Celsius, and
b) a layer of a microwaveable coating, the coating comprising;
   i) a microwave interactive material of carbon and
   ii) a binder comprising a silicate or a naturally occurring polymer, or a derivative thereof.

In one embodiment, the invention further relates to a structure for cooking or heating food, comprising:
a) a nonwoven base layer comprising a polymeric material with glass transition temperature t_{g} greater than 240 degrees Celsius or a melting temperature tₘ greater than 270 degrees Celsius, and
b) an intermediate layer comprising a cellulosic polymer, or naturally occurring polymer which is not a cellulosic polymer, or derivative thereof; and
c) a layer of a microwaveable coating, the coating comprising;
   i) a microwave interactive material of carbon, and
   ii) a binder comprising a silicate or naturally occurring polymer, or a derivative thereof.

### BRIEF DESCRIPTION OF THE DRAWINGS

FIG. 1 is an embodiment of this invention comprising a microwave interactive layer deposited on a high temperature base layer, not drawn to scale.

FIG. 2 is another embodiment of this invention comprising a base layer, intermediate layer, and microwave interactive layer, not drawn to scale.

FIG. 3 is a layered structure representing a prior art microwave susceptor structure.

FIG. 4 is a layered structure representing another prior art microwave susceptor structure.

### DETAILED DESCRIPTION OF THE INVENTION

This invention relates to a structure for cooking or heating food comprising a nonwoven base layer comprising a polymeric material having a glass transition temperature greater than 240 degrees Celsius or a melting temperature greater than 270 degrees Celsius. The structure is provided with a continuous or discontinuous coating that further comprises a binder and a microwave interactive material.

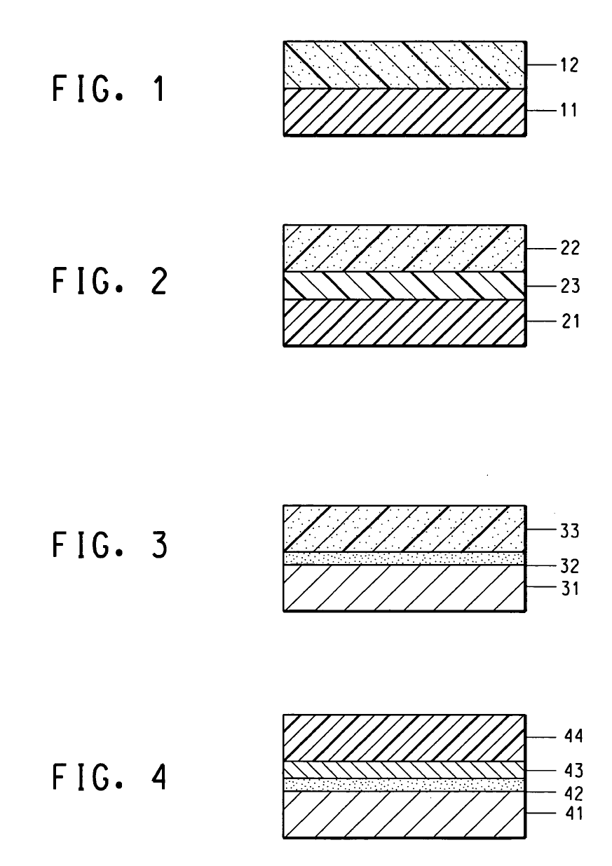

The structure is provided with a coating comprising a binder and a microwave interactive material. FIG. 1 shows a structure of this invention comprising a base layer (11) and a microwave interactive layer (12) deposited on it. The microwave interactive layer may be continuous or discontinuous.

FIG. 2 shows an alternative structure of this invention comprising a base layer (21), intermediate layer (22), and microwave interactive layer (23) which may be continuous or discontinuous. The inventors believe that the intermediate layer fills any pores or gaps in the surface of the base layer, thus providing a more uniform layer upon which the microwave interactive layer is deposited. It is believed the conductivity of the microwave interactive layer is improved resulting in improved efficiency in the conversion of microwave energy into heat. Additionally the inventors believe that an intermediate layer also further improves the safety of the susceptive structure by providing thermal insulation to the base layer further preventing overheating. The intermediate layer preferably comprises materials suitable for food contact. Suitable materials include but are not limited to cellulosic materials, vegetable proteins, animal proteins, or derivatives thereof.

FIG. 3 is a comparative example from the prior art showing a base layer of paperboard (31), an intermediate layer of sodium silicate (32), and microwave interactive layer comprising carbon and sodium silicate (33). This structure is limited to the ignition temperature of paperboard as the maximum safe temperature.

FIG. 4 is a comparative example from the prior art showing a paperboard base layer (41), an adhesive layer (42), a layer of metal (typically aluminum) (43), and a polyethylene terephthalate barrier layer (44). This multilayered structure is both limited to the ignition temperature of paperboard and requires a barrier layer between the food and adhesive to prevent potentially dangerous chemicals from migrating into the food during heating. The PET film also limits the maximum temperature of the susceptor due to shrinkage of the PET film at about 180 degrees Celsius. The shrinkage causes cracks to form in the film (“crazing”) which reduces the ability of the layer of microwave interactive material to convert microwave energy to heat.

The base layer comprises a paper that is essentially transparent to microwave radiation. Specifically, papers useful as the base layer are made from materials that are stable at high temperatures. This provides the layer with dimensional stability at temperatures above 240 degrees Celsius adequate to allow the microwave interactive material to convert a portion of incident microwave energy into heat for the duration necessary to cook a food article. Preferably the paper comprises polymeric materials having a glass transition temperature (t_{g}) of greater than 240 degrees Celsius or a melting temperature (tₘ) of greater than 270 degrees Celsius. The glass transition temperature is defined as the temperature below which an amorphous polymer is considered to be a glass. The melting temperature is defined as the temperature at with a material undergoes a phase transition from the solid state to the liquid state. Many polymers contain both regions of crystallinity and amorphous regions. Such polymers normally possess both a (t_{g}) and a (tₘ.)

Papers are well known in the art and can be made on conventional paper machines. Paper base layers and methods for making such base layers are disclosed in Gross, Kirayoglu, Hesler, and Tokarsky in U.S. Pat. Nos. 3,756,908; 4,698,267; 4,729,921; 5,026,456; 5,223,094; 5,314,742; and 5,910,231. Alternatively, nonwoven spunlaced structures made with high temperature fibers are useful as base layers. General methods for the production of spunlaced materials are disclosed in U.S. Pat. Nos. 5,240,764; 3,485,706; 4,891,262; 2,451,915; 2,700,188; 2,703,441; and 4,902,564.

Base layers of this invention comprise polymeric materials with a (t_{g}) of greater than 240 degrees Celsius or a(tₘ) greater than 270 degrees Celsius. Suitable materials include but are not limited to aramids, polybenzoxazoles, polybenzothiazoles, and polybenzimidazoles. Preferably, the base layer comprises aramid fiber. More preferably the base layer comprises para-aramid fiber.

By “aramid” is meant a polyamide wherein at least 85% of the amide (—CO—NH—) linkages are attached directly to two aromatic rings. Suitable aramid fibers are described in Man-Made Fibers—Science and Technology, Volume 2, Section titled Fiber-Forming Aromatic Polyamides, page 297, W. Black et al., Interscience Publishers, 1968. Aramid fibers are, also, disclosed in U.S. Pat. Nos. 4,172,938; 3,869,429; 3,819,587; 3,673,143; 3, 354,127; and 3,094,511.

The coating of the invention comprises a binder material and microwave interactive material. There are various methods of depositing the coating composition on the base layer. Suitable methods include printing techniques such as wet film application, gravure printing, screen printing, and flexographic printing. Preferably, the deposition technique is one in which the microwave interactive material is deposited from solution.

Solutions of microwave interactive coating compositions are typically prepared from substantially non-aggregated particles of the microwave interactive material, a soluble binder, and optional additional processing aids dissolved in a solvent. Suitable processing aids include dispersing aids, biocides, pH modifiers, or defoamers. The particles of microwave interactive material tend to agglomerate and form aggregates. Coatings containing significant numbers of aggregate particles create arcs when exposed to microwave radiation necessary to cook food which can burn the food and damage the microwave oven. Therefore, the microwave interactive material is treated during the manufacture of the coating composition, preferably by milling in water, to reduce the size and number of aggregates. Therefore, by substantially non-aggregated it is meant the particulate microwave interactive material has been mechanically or otherwise treated to de-agglomerate a majority of the aggregates formed by the microwave interactive material

The coating compositions used in this invention have a high solids content and preferably do not contain any additives used expressly to attenuate or reduce the heat generated by the carbon from the microwave radiation. If the coating is to be used in a gravure printing process, the solids content of the coating composition is greater than 20 percent and generally in the range of 22 to 26 percent or higher based on whether or not a surfactant is included with the microwave susceptor and the binder polymer. If the coating composition is to be used in a screen printing process, the solids content of the coating composition is greater than 25 percent and generally in the range of 35 percent or higher, based on whether or not a surfactant and/or a humectant is included with the microwave susceptor and the binder polymer.

The coating compositions used in this invention have a fluid viscosity suitable for them to be printed onto substrates, and the viscosity is highly dependent on the printing process. For screen printing a viscosity of about 5,000 centipoise or greater is desired, while for gravure printing a viscosity of about 500 centipoise or less is desired. Alternatively, other health-friendly additives and/or pigments can be added as long as the final coating composition performs and is safe for food contact.

The coating composition can contain additives that maintain shelf-life or assist in the printing process. For example, since natural polymers are used a biocide may need to be added to prevent souring of the ink. The coating composition can also be tailored for the printing process that is to be used, for example, to make a screen printing ink a humectant can be added to decrease drying rate and improve screen life.

These coating compositions are preferably printed or coated onto a substrate in such quantity so as to create a cooking surface on that substrate that has in excess of 35 weight percent microwave susceptor particles that are both substantially non-aggregated and uniformly dispersed in the natural polymer binder. Such coatings are used to cook food, these coatings can achieve very high temperatures when contacted with microwave energy without burning the susceptive structure or creating damaging arcs to the food or the microwave oven. Typically, the microwave interactive coating comprises 30 to 75 parts by weight of binder and 25 to 70 parts by weight of microwave interactive material. Preferably, the coating comprises 40 to 65 parts by weight of binder and 35 to 60 parts by weight of microwave interactive material.

A continuous layer is a layer in which the layer is uninterrupted. A discontinuous layer is a layer which is not continuous. A discontinuous layer may be discontinuous in uniformity with interruptions or may have a number of individual, discrete areas (which may be uniform or non-uniform in the layer).

The binder comprises a material that is capable of being doped or coated with a microwave interactive material and deposited on a base layer. A desirable binder will preferably be soluble in water or alcohols, able to withstand temperatures above 200 degrees Celsius without changing phase, able to withstand temperatures above 200 degrees Celsius without rapid decomposition, safe for contact with food, and be electrically non-conductive or semi-conductive. Suitable binders include but are not limited to polysaccharides, such as cellulose derivatives, starch and starch derivatives, gums and derivatized gums, algins and derivatives, carrageenans, agars, furcellarans, chitin and chitosan; plant proteins such as soy or legume protein; animal proteins such as fish protein or collagen; and silicates such as sodium silicate. Preferably, the binder is a naturally occurring polymer such as a plant protein. The preferred binder is soy protein or derivative thereof.

The microwave interactive material of the invention comprises carbon such as in the form of carbon fiber or carbon black, or graphite. Carbon based interactive materials are easily processed and deposited. Carbon based inks are well known in the art and common printing techniques such as screen, gravure, and flexographic printing are used to deposit carbon based solutions. Microwave interactive coatings of carbon based materials allow for easily customizable coating thicknesses, concentrations, and patterns. Carbon based microwave interactive materials are in addition easily milled to control the particle size distribution, and carbon/binder compositions are easily solublized or suspended in common solvents such as water and alcohols allowing efficient handling.

This invention may include a process for making a structure for microwave cooking comprising providing a base layer comprising a paper, wherein the paper further comprises a polymeric material with glass transition temperature t_{g} greater than 240 degrees Celsius or a melting temperature tₘ greater than 270 degrees Celsius, and depositing a continuous or discontinuous microwave interactive coating on said base layer, wherein the coating comprises a binder comprising a cellulosic, or naturally occurring material, or derivative thereof, and the microwave interactive material comprises carbon such as carbon fiber, carbon black, and graphite.

This invention also includes a process for making a alternative structure for microwave cooking comprising providing a base layer, depositing an intermediate layer on said base layer, wherein the intermediate layer comprises a silicate, a naturally occurring material, or a derivative thereof, and depositing a continuous or discontinuous microwave interactive coating on said intermediate layer, wherein the coating comprises a binder comprising a cellulosic, or naturally occurring material, or derivative thereof, and the microwave interactive material is carbon, carbon fiber, carbon black; and graphite.

The invention also relates to a method for microwaving food in contact with the structure of the invention by providing a microwaveable structure comprising a base layer and a microwave interactive coating, placing a food article in contact with the microwave interactive coating, applying microwave energy to the food and said structure of sufficient intensity to cook the food.

### Test Methods

Microwave Heating Test

Microwave heating effectiveness was measured by use of an oil/water competition test. This test gives a quantitative measure of heating power for different susceptors by cooking oil in a glass beaker above a susceptor in competition with a water-filled beaker without susceptor. The microwave and apparatus used in this test has been shown to give a 7.8 degree rise in temperature without a susceptor (or with an uncoated dielectric substrate). For susceptive-coated samples, the temperature rise of the oil in excess of 7.8 degrees for a 60 second test run shows a functioning susceptor. In addition, the test conditions serve as a useful proxy for imperfect food contact or for overcooking excursions with food because of the harshness of the test—since there is some thermal lag within the glass and imperfect contact of susceptor to glass because of beaker geometry (slightly concave bottom).

100 grams of Type 710 oil was placed in a 250 mL beaker. 400 mL of distilled water was placed in a 600 mL beaker. A 4.1 cm circle was cut from the test microwavable substrate material. The oil and water initial temperature was measured and recorded. Both beakers were placed in a Emerson 900 Watts, Model Number MW8987B microwave oven with the water beaker placed to one side and oil beaker sitting on the microwavable substrate (with the active side of the microwavable substrate facing towards the oil beaker bottom). The oil beaker should be centered on the microwavable substrate and centered in the microwave on the turntable. The microwave was then run on high heat for 1 minute and 3 seconds. The sample was monitored and if flames or arcing appeared the test was stopped. Once time has expired (or test stopped) the temperature of the oil (first) and then the water was measured and recorded. The microwavable substrate was examined for signs of arcing (jagged, burned out lines), which were noted if present. The difference between the oil start and finish temperature was calculated.

### EXAMPLE 1

Aramid with Carbon-Soy

A dispersion aid, water and defoamer were mixed together with a Cowles blade at 1000 rpm. Carbon black was then added while under agitation and allowed to mix at 2000 rpm for 2 hours. The carbon dispersion was milled in a horizontal media mill. Milling was done with 0.8-1.0 mm zirconia media and ceramic agitator operating at a tip speed of 2400 feet per minute for a batch residence time of 62 minutes. Water was then mixed into the milled dispersion at low speed. Ammonium hydroxide was then added to raise the pH of the mixture above 10.0.

A soy-carbon ink was then prepared. Soy protein (Procote 2500) and ammonium hydroxide were added in aliquots of 10 g protein followed by 1.5 g ammonium hydroxide until the formula amount of protein was mixed in. The mixing speed was increased to a point that provided a stable mixing vortex without excessive air entrainment, and the mixture was mixed at this higher speed for 1 hour. Mixing speed was then reduced and the mixture pH was adjusted above 9.5 with ammonium hydroxide; glycerin, biocide (Proxel GXL), and remaining water were added with mixing, and the mixture was mixed for an additional 15 minutes.

| Component | Ink |
|---|---|
| Carbon black | 11.0 |
| (Cabot Black | |
| Pearls 4350) | |
| Dispersing aid | 4.4 |
| (Tween 80) | |
| Soy protein (Pro- | 10.1 |
| cote 2500) | |
| NH3 | 1.8 |
| Glycerin | 1.0 |
| Water | Remainder |
| Biocide (Proxel | 0.2 |
| GXL) | |
| Defoamer (SAG | 0.02 |
| 770) | |

A coated microwave susceptor was prepared. The substrate used was a sheet of 30 cm length by 30 cm width, 0.1 mm thickness aramid paper (Type 4N710 from DuPont). A uniform base coat of 0.127 mm (5 mils) wet film thickness was first applied to the substrate using a wet film applicator available from Paul N. Gardner Company. The composition of the base coat was 14.7% modified soy protein (Pro-cote 200 from Bunge), 1.1% glycerin, 0.74% ammonia, and 83.46% water. The coated sheet was dried in a 100 degree C. oven for 15 minutes. A second coating of microwave susceptor ink (prepared and of the composition listed above was applied using the wet film applicator at a 5 mil wet thickness. The sheet was dried for 30 minutes in a 100 degree C. oven. Oil and beaker tests were run on cut samples from the sheet with results in Table 1.

### EXAMPLE 2

Aramid with Carbon-Sodium Silicate

A sample of carbon dispersion similar to that of Example 1 was mixed with commercial sodium silicate (Oxychem 40 Clear) in appropriate amounts to achieve an equal weight percentage of carbon and (dry) sodium silicate, using hand stirring. A coated susceptor sheet was prepared by depositing a wet 5 mil coating of sodium-silicate-carbon ink onto a sheet of aramid paper (Type 4N710 from DuPont) with the applicator of Example 1. The sheet was dried for 30 minutes in a 100 degree C. oven. Oil and beaker heating tests were run on cut samples with the results in Table 1.

### EXAMPLE 3

Cellulose with Carbon-Soy

A cellulose paper was prepared. Cellulose pulp was placed in a Waring Blendor with 800 ml of water and was agitated for 5 min. The slurry was poured, with 4 additional liters of water, into an approximately 21×21 cm handsheet mold and a wet-laid sheet was formed. The sheet was placed between two pieces of blotting paper, hand couched with a rolling pin, and dried in a handsheet dryer at 180° C. The resultant sheet had a basis weight of 1.3 ounces per square yard.

The sheet was precoated with 4 mil of soy solution, dried and then coated with 5 mil of carbon-soy ink in the manner of Example 1. Oil and beaker heating tests were performed on cut samples with the results in Table 1.

### EXAMPLE 4

Cellulose-Para-Aramid with Carbon-Soy

A para-aramid-cellulose paper was prepared. Cellulose pulp was placed in a Waring Blendor with 800 ml of water and was agitated for 5 min. After that the slurry of cellulose pulp was mixed with p-aramid pulp (25/75 weight percent of cellulose to para-aramid) in a laboratory mixer (British pulp evaluation apparatus) with about 1600 g of water. After agitating for 2 min., the final slurry was prepared. The slurry was poured, with 4 additional liters of water, into an approximately 21×21 cm handsheet mold and a wet-laid sheet was formed. The sheet was placed between two pieces of blotting paper, hand couched with a rolling pin, and dried in a handsheet dryer at 180° C. Calendering was conducted between two metal rolls (20.3 cm diameter each) at room temperature and linear pressure of about 2800 N/cm. The resultant sheet had a 2.6 ounce per square yard basis weight.

The sheet was precoated with 4 mil of soy solution, dried and then coated with 5 mil of carbon-soy ink in the manner of Example 1. Oil and beaker heating tests were performed on cut samples with the results in Table 1.

### EXAMPLE 5

PET with Carbon-Soy

A commercial nonwoven sheet of PET (1.8 ounces per square yard basis weight) was coated with 4 mils of carbon-soy ink in the manner of Example 1 and dried for 30 minutes in a 100 degree oven. Oil and beaker heating tests were performed on cut samples with the results in Table 1.

TABLE 1
Oil and water heating tests

| | | Oil delta T | Microwave | | Substrate |
|---|---|---|---|---|---|
| Example | Sample | (degrees C.) | Time | Observations | integrity |
| 1 (Aramid with | 1 | 12.5 | 63 | — | Maintained |
| carbon-soy) | | | | | integrity, |
| | | | | | some |
| | | | | | browning of |
| | | | | | substrate |
| | 2 | 13.5 | 63 | — | Maintained |
| | | | | | integrity, |
| | | | | | some |
| | | | | | browning of |
| | | | | | substrate |
| | 3 | 14.2 | 63 | — | Maintained |
| | | | | | integrity, |
| | | | | | some |
| | | | | | browning of |
| | | | | | substrate |
| | 4 | 12.8 | 63 | — | Maintained |
| | | | | | integrity, |
| | | | | | some |
| | | | | | browning of |
| | | | | | substrate |
| 2 (Aramid with | 1 | 12.3 | 63 | — | Maintained |
| carbon-sodium | | | | | integrity |
| silicate) | | | | | |
| | 2 | 12.6 | 63 | — | Maintained |
| | | | | | integrity |
| | 3 | 15.6 | 63 | — | Maintained |
| | | | | | integrity |
| | 4 | 11.3 | 63 | — | Maintained |
| | | | | | integrity |
| 3 (Cellulose with | 1 | 15.4 | 63 | — | Burned |
| carbon-soy) | | | | | hole in |
| | | | | | susceptor |
| | 2 | 17.2 | 63 | — | Burned |
| | | | | | hole in |
| | | | | | susceptor |
| 4 (Kevlar-cellulose | 1 | 18.0 | 63 | Crack formed | Maintained |
| with carbon-soy) | | | | in oil beaker | integrity, |
| | | | | | some |
| | | | | | browning of |
| | | | | | substrate |
| | 2 | 20.6 | 63 | — | Maintained |
| | | | | | integrity, |
| | | | | | some |
| | | | | | browning of |
| | | | | | substrate |
| 5 (PET with | 1 | 5.9 | 24 | Arced, | Melted |
| carbon-soy) | | | | stopped test | |
| | 2 | 3.5 | 13 | Arced, | Melted |
| | | | | stopped test | |
| | 3 | 5.6 | 22 | Arced, | Melted |
| | | | | stopped test | |
| | 4 | 13.5 | 63 | — | Melted |

### DISCUSSION OF EXAMPLES

The various carbon samples that ran to full time all showed higher delta T (11-20 degrees C.) than the “no susceptor” calibrated reading of 7.8 degrees. This indicates that all samples had sufficient microwave susceptor action to produce noticeable heating in competition with a water load (food proxy). However, the samples with lower temperature substrates (PET, cellulose) did not maintain integrity and either burned or melted under the conditions of the microwave heating test. In contrast, carbon-based susceptors on high temperature substrate (aramid) maintained integrity. In addition, the para-aramid/cellulose blended sheet susceptors show that effective substrate sheets may be made which consist of blends of high temperature and low temperature materials, to at least 25% lower temperature material within the blend.

Although not tested, it is reasonable to believe that assume that someone skilled in the art may produce substrate sheets with blended high temperature materials (e.g. aramid/polybenzoxazole) and produce a carbon-binder coated susceptor with acceptable thermal endurance. Such blended high temperature materials might also have up to 25% of a lower temperature thermal endurance material (e.g. cellulose or PET) in an analogous manner to the para-aramid/cellulose blend. Such addition might be useful for cost reduction or for creating a sheet structure itself (e.g. binding substrate sheet fibers) or to improve sheet properties such as porosity, printability, or dimensional stability.

1. A structure for cooking or heating food, comprising:
a) a nonwoven base layer comprising a polymeric material with glass transition temperature t_{g} greater than 240 degrees Celsius or a melting temperature tₘ greater than 270 degrees Celsius, and
b) a layer of a microwaveable coating, the coating comprising:
i) a microwave interactive material of carbon and
ii) a binder comprising a silicate or a naturally occurring polymer or a derivative thereof.

2. The structure of claim 1 wherein the base layer comprises nonwoven paper.

3. The structure of claim 2 wherein the base layer comprises aramid.

4. The structure of claim 3 wherein the base layer comprises para-aramid.

5. The structure of claim 1 wherein the base layer comprises a spunlaced sheet.

6. The structure of claim 1 wherein the binder is selected from the group consisting of soy protein, animal protein, silicates, polysaccharides, derivatives, and mixtures thereof.

7. The structure of claim 1 wherein the layer of microwaveable coating is continuous.

8. The structure of claim 1 wherein the layer of microwaveable coating is discontinuous.

9. A structure for cooking or heating food, comprising:
a) a nonwoven base layer comprising a polymeric material with glass transition temperature t_{g} greater than 240 degrees Celsius or a melting temperature tₘ greater than 270 degrees Celsius, and
b) an intermediate layer comprising:
a cellulosic polymer, or naturally occurring polymer which is not cellulosic, or derivative thereof;
c) a layer of a microwaveable coating, the coating comprising;
i) a microwave interactive material of carbon and
ii) a binder comprising a silicate or a naturally occurring polymer or a derivative thereof.

10. The structure of claim 9 wherein the base layer comprises nonwoven paper.

11. The structure of claim 9 wherein the base layer comprises aramid.

12. The structure of claim 9 wherein the base layer comprises para-aramid.

13. The structure of claim 9 wherein the base layer comprises a spunlaced sheet.

14. The structure of claim 9 wherein the binder or intermediate layer is selected from the group consisting of soy protein, animal protein, silicates, polysaccharides, derivatives, and mixtures thereof.

15. The structure of claim 9 wherein the layer of microwaveable coating is continuous.

16. The structure of claim 9 wherein the layer of microwaveable coating is discontinuous.

17. A method of heating a food in contact with a structure comprising:
a) a nonwoven base layer comprising a polymeric material with glass transition temperature t_{g} greater than 240 degrees Celsius or a melting temperature tₘ greater than 270 degrees Celsius, and
b) a layer of a microwaveable coating, the coating comprising:
iii) a microwave interactive material of carbon and
iv) a binder comprising a silicate or a naturally occurring polymer or derivative thereof
wherein the food is in contact with (b) comprising the step of applying microwave energy to the food and structure.
